(19) United States
(12) Patent Application Publication
(10) Pub. No.: US 2003/0227838 A1
(43) Pub. Date: Dec. 11, 2003

(54) Optical disk and optical disk recording/reproducing apparatus

(75) Inventor: Hideyuki Fujimoto, Tsurugashima-shi (JP)

Correspondence Address: SUGHRUE MION, PLLC, 2100 Pennsylvania Avenue, NW, Washington, DC, 20037-3213, US

(73) Assignee: PIONEER CORPORATION

(21) Appl. No.: 10/426,962

(22) Filed: May 1, 2003

(30) Foreign Application Priority Data
May 1, 2002 (JP) P2002-130072

(51) Int. Cl. G11B 7/095

(52) U.S. Cl. 369/44.26; 369/44.34

(57) ABSTRACT

An optical disk has a servo area composed of a synchronous pit and guard pits provided on each track and a data area composed of data pits. In recording and reproducing digital data on and from the optical disk, a beam spot of laser beam is traced on centerlines between adjacent two tracks. In the tracking of this case, a reflected light is changed due to a tracking error with an arrangement of the synchronous pit and the guard pits on an odd track and an arrangement of the synchronous pit and the guard pits on an even track. A tracking servo is made by comparing output levels of the reflected light changed before and after this synchronous pit.

### BACKGROUND OF THE INVENTION

1. Field of the Invention

The present invention relates to an optical disk with a sample servo method, and more particularly to a technical field of an optical disk having a pit configuration for tracking servo that is suitable for a high recording density, and an optical disk recording/reproducing apparatus for performing at least one of recording and reproducing data on and from the optical disk.

2. Description of the Related Art

Conventionally, an information recording medium that records information at high density to store a large amount of information, and its recording or reproducing apparatus have been developed. Particularly, with the expansion of a computerized society, the increasing amount of information is dealt with, and the portable uses are spread, whereby there is a demand for the information recording medium of small size, high density and large capacity. In such a situation, an optical disk for optically recording and reproducing data having excellent operability has been vigorously employed, such as CD-ROM (Compact Disc-Read Only Memory), MD (Mini Disc), DVD, and DVD-ROM (Digital Versatile Disc-Read Only Memory).

To control the recording and reproducing of the optical disk, there is a need for a tracking servo for enabling a light beam spot to follow a track, a focus servo for focusing, and a spindle motor servo for controlling the number of revolutions of the optical disk. Accordingly, an error signal is detected for each servo control. For example, for the spindle servo, an error signal is detected on the basis of a synchronizing signal extracted from a reproduced signal and an output from a revolution number detector provided on the spindle motor. For the tracking servo or focus servo, error signals are detected from the reproduced signal of the optical disk, on the basis of control pits formatted in accordance with a sampled servo method, or on the basis of the composition of an optical pickup.

An optical disk system for recording and reproducing the information by enabling a light beam spot to be traced on a center between two tracks in which a pit (here, the “pit” means a concavity corresponding to the recording information, formed along a track direction of the optical disk) for the higher recording density is made smaller, and an interval of recording track is made narrower has been offered and implemented. In such an optical disk, control pits are provided at a predetermined position in the track for the tracking servo, apart from data pits, and a tracking error signal is produced by reading the control pits.

However, with the conventional method, the control pits with periodicity that is provided on the track restricts the area for data pits, so that the data recording capacity is decreased. Also, if the pit is made shorter to suppress a decrease in the data recording capacity to the minimum, the pit period approaches a diffraction limit, so that the amplitude of reproduced signal is decreased. Therefore, the reproduced signal for two pits for tracking servo located on adjacent two tracks has a smaller amplitude difference, resulting in a problem that a tracking error can not be accurately detected.

### SUMMARY OF THE INVENTION

Accordingly, the present invention has been achieved in the light of the above-mentioned problems, and it is an object of the invention to provide an optical disk having a pit format in which the area occupied by a pit for tracking servo is reduced and the recording capacity of information is kept large, and an optical disk recording/reproducing apparatus for performing at least one of recording and reproducing data on and from the optical disk.

In one aspect of the present invention, an optical disk having a synchronous pit serving as a synchronizing reference for recording/reproducing, guard pits and data pits on each track, is provided with: on an odd track, a first land having a first length between the synchronous pit and the guard pit provided forward of the synchronous pit; and a second land having a second length between the synchronous pit and the guard pit provided backward of the synchronous pit; on an even track, a third land having a third length between the synchronous pit and the guard pit provided forward of the synchronous pit; and a fourth land having a fourth length between the synchronous pit and the guard pit provided backward of the synchronous pit, wherein a tracking error signal is detected on the basis of a reflected light from the first land, the third land, and a land between the odd track and the even track adjacently provided, and a reflected light from the second land, the fourth land, and a land between the odd track and the even track adjacently provided.

The optical disk of the present invention employs a sample-and-hold method, in which a synchronous pit as a control pit for recording or reproducing data on or from the optical disk, and guard pits before and after the synchronous pit are arranged. The guard pits with respect to the synchronous pit are arranged differently depending on whether an odd track or an even track. Depending on whether the guard pit is arranged before or after the synchronous pit, a distance between the synchronous pit and the guard pit is different, namely, a length of land between them is different. Due to the difference in the arrangement or distance, when the beam spot is traced off the track, the amount of reflected light is changed, whereby it is discriminated whether or not the beam spot is deviated in accordance with a signal based on this amount of change, and to which side it is deviated, if any. Then, a tracking error signal is detected.

The optimal positional relation between the synchronous pit and the guard pits for the optical disk of the present invention, the optimal relation with the beam spot, and the detection of tracking error in employing the optical disk of the present invention will be apparent from the following description.

In this application, the “recording direction or reproducing direction of the optical disk” means a direction from left to right in FIG. 1, the “forward” means the left side of the reference position in FIG. 1, and the “backward” means the right side of the reference position in FIG. 1. Also, the “leading part of pit” means a pit edge on the left side of pit, and the “trailing part of pit” means a pit edge on the right side of pit. Also, in this application, the “pit composed of concavity” means a concave portion as seen from one surface of the optical disk, but a convex portion as seen from the opposite surface. That is, the concave and convex of pit have the relative meaning. For example, the pit is concave as seen from the side where a recording light or a reproducing light is radiated.

In another aspect of the present invention, the first length of the first land is equal to the fourth length of the fourth land, and the second length of the second land is equal to the third length of the third land.

In this aspect, the distance between the synchronous pit and the guard pit arranged forward of it, or the land length, on the odd track, and the distance between the synchronous pit and the guard pit arranged backward of it, or the land length, on the even track are equal. Also, the distance between the synchronous pit and the guard pit arranged backward of it, or the land length, on the odd track, and the distance between the synchronous pit and the guard pit arranged forward of it, or the land length, on the even track are equal.

In this aspect, “equal” in the “land length is equal” means literally equal, or slightly different in length so far as the lands or pits are regarded as the same land or pit in the relation with the diameter of beam spot of the recording light or reproducing light practically used, and in the relation with the resolution.

In further aspect of the present invention, the first length of the first land is not equal to the second length of the second land.

In this aspect, the second length is different from the first length. Hence, when the beam spot is traced off the track, a tracking error signal is detected.

In further aspect of the present invention, the second length of the second land is two times longer than the first length of the first land, and the second length of the second land is two times longer than an average length of the data pits.

In this aspect, the second length is double the first length as well as double the average length of data pits corresponding to the recorded information. The average length of data pits is one when the information is recorded in multi-values corresponding to the edges of data pits.

In this aspect, “equal” means literally equal or slightly different in length so far as the lands or pits are regarded as the same land or pit in the relation with the diameter of beam spot of the recording light or reproducing light practically used, and in the relation with the resolution of recording or reproducing.

In further aspect of the present invention, the synchronous pit on said each track is arranged at the same position in a radial direction of the optical disk.

In this aspect, the synchronous pit is linearly provided in a radial direction of the optical disk. Synchronism is detected in whole area of the optical disk, and used for the recording and reproducing control of the optical disk. Also, the reversal of the odd track and the even track is detected for every synchronous pit, and a tracking error is detected from the relation between the synchronous pit and the guard pits corresponding to each track.

In this aspect, the “same position” means literally the identical position or a slightly different position so far as the lands or pits are regarded as the same land or pit in the relation with the diameter of beam spot of the recording light or reproducing light practically used, and in the relation with the resolution of recording or reproducing.

In further aspect of the present invention, the synchronous pit has a longer shape than the guard pits and the data pits.

In this aspect, the synchronous pit is formed longer than other pits, and can detect the synchronism correctly.

In further aspect of the present invention, a trailing part of the guard pit arranged backward of the synchronous pit on the odd track is modulated in accordance with the recorded data.

In this aspect, the guard pit is employed as a part of recorded information, whereby the recording capacity is increased.

In further aspect of the present invention, a leading part of the guard pit arranged forward of the synchronous pit on the even track is modulated in accordance with the recorded data.

In this aspect, the guard pit is also employed as a part of recorded information, whereby the recording capacity is increased.

In further aspect of the present invention, the data pit is recorded in multi-valued digital information as the positional information of the pit edge.

In this aspect, the data pit records the information corresponding to the position of its edge, whereby more information can be represented by one data pit, and the recording capacity is increased.

In further aspect of the present invention, a material capable of optically forming the data pit is provided at least between the adjacent two tracks of the optical disk.

In this aspect, one type of the optical disk of this invention employs a material capable of optically forming the pit on an entire surface of the optical disk, or at least between adjacent two tracks. For example, this optical disk may be a write-once disk having a pigment film, and a rewritable disk having a phase change film or MO film.

In one aspect of an optical disk recording/reproducing apparatus of the present invention, which is apparatus for performing at least one of recording and reproducing data on and from an optical disk having a synchronous pit as a synchronization reference for recording/reproducing, guard pits and data pits on each track, the optical disk recording/reproducing apparatus is provided with: an optical device which performs at least one of recording and reproducing data by radiating a beam spot of laser beam over two adjacent tracks of the optical disk; a tracking error detecting device which detects a tracking error signal on the basis of a reflected light from a land between the synchronous pit and the guard pit and a land provided between the adjacent two tracks; and a tracking servo device which enables the beam spot of laser beam to trace the center between the adjacent two tracks on the basis of the tracking error signal by the tracking error detecting device.

The optical disk recording/reproducing apparatus of the invention records or reproduces the information on or from the optical disk having the pit configuration of the invention, in which a tracking error is detected on the basis of a reflected light from the land between the synchronous pit and the guard pits and the land provided between adjacent two tracks by radiating a beam spot of laser beam over adjacent two tracks, and the beam spot is traced on the center between adjacent two tracks with the tracking servo. In this tracing state, the information is reproduced from one data pit of adjacent two tracks, or the data pit is formed or information is recorded on the land portion between adjacent two tracks.

In another aspect of the present invention, the tracking error detecting device samples, at a predetermined position, a reproduced signal level on the basis of a reflected light from the land between the synchronous pit and the guard pit arranged forward of the synchronous pit and the land provided between the adjacent two tracks, and a reproduced signal level on the basis of a reflected light from the land between the synchronous pit and the guard pit arranged backward of the synchronous pit and the land provided between the adjacent two tracks, and detects a tracking error by comparing the sampled values.

In this aspect, the detection of tracking error is made by detecting the reflected light from the land portion provided between the synchronous pit and the guard pits before and after the synchronous pit and the land which is located between adjacent two tracks and at the same position as the land portion at each position before and after the synchronous pit. The output of detection is sampled at a predetermined position of the land portion, and by comparing two sampled values, it is discriminated whether or not there is any tracking error, and if so, to which side the tracking is deviated. If there is any tracking error, the tracking servo is made on the basis of a comparison result of two sampled values.

This detection way of tracking error allows the tracking error signal to be detected at high sensitivity by appropriately setting the land lengths L1 and L2. When the track pitch is narrow, or the pit period is short, the tracking servo is made stably and correctly.

In further aspect of the present invention, a comparison result of the sampled values by the tracking error detecting device is supplied to the tracking servo device, with the polarity reversed for each track.

In this aspect, since the arrangement of the synchronous pit and the guard pits is changed every track, the relation between the direction of track deviation and the polarity of the tracking error signal is reversed every track. Thus the polarity should be reversed every track to make the correct tracking.

In further aspect of the present invention, a comparison result of the sampled values by the tracking error detecting device is supplied to the tracking servo device, with the polarity reversed for each frame.

In this aspect, since the arrangement of the synchronous pit and the guard pits is changed every frame, the relation between the direction of track deviation and the polarity of the tracking error signal is reversed every frame. Thus the polarity should be reversed every frame to make the correct tracking.

The operation and other benefits of the present invention will be clarified from the following description of the embodiments.

### BRIEF DESCRIPTION OF THE DRAWINGS

FIG. 1 is a view showing a pit configuration and its arrangement of a ROM type disk involving an optical disk according to the present invention;

FIG. 2 is a view showing a pit configuration and its arrangement of a conventional ROM type disk;

FIG. 3A is a view showing a relation between a pit arrangement and a light beam, and a sample extracting point for tracking servo, in which a beam spot lies on an odd centerline;

FIG. 3B is a view showing a relation between a pit arrangement and a light beam, and a sample extracting point for tracking servo, in which a beam spot lies on an even centerline;

FIG. 4A is a view showing an output signal at a sample extracting point for tracking servo, corresponding to FIG. 3A, in which a beam spot lies on a centerline;

FIG. 4B is a view showing an output signal at a sample extracting point for tracking servo, corresponding to FIG. 3A, in which the beam spot is deviated upward from a centerline;

FIG. 4C is a view showing an output signal at a sample extracting point for tracking servo, corresponding to FIG. 3A, in which the beam spot is deviated downward from a centerline;

FIG. 5A is a view showing an output signal at a sample extracting point for tracking servo, corresponding to FIG. 3B, in which a beam spot lies on a centerline;

FIG. 5B is a view showing an output signal at a sample extracting point for tracking servo, corresponding to FIG. 3B, in which the beam spot is deviated upward from a centerline;

FIG. 5C is a view showing an output signal at a sample extracting point for tracking servo, corresponding to FIG. 3B, in which the beam spot is deviated downward from a centerline;

FIG. 6A is a view showing a relation between the arrangement of the synchronous pit and the guard pit and the beam spot for the optical disk according to the present invention;

FIG. 6B is a view showing a relation between the arrangement of the synchronous pit and the guard pit and the beam spot for the optical disk according to the present invention;

FIG. 6C is a view showing a relation between the arrangement of the synchronous pit and the guard pit and the beam spot for the optical disk according to the present invention;

FIG. 7 is a view showing a pit configuration and its arrangement involving an optical disk for recording, and a relation between the beam spot and data pits to be recorded; and

FIG. 8 is a block diagram of an optical disk recording/reproducing apparatus for recording data on and reproducing data from the optical disk of the present invention.

### DETAILED DESCRIPTION OF THE PREFERRED EMBODIMENTS

First Embodiment of Optical Disk

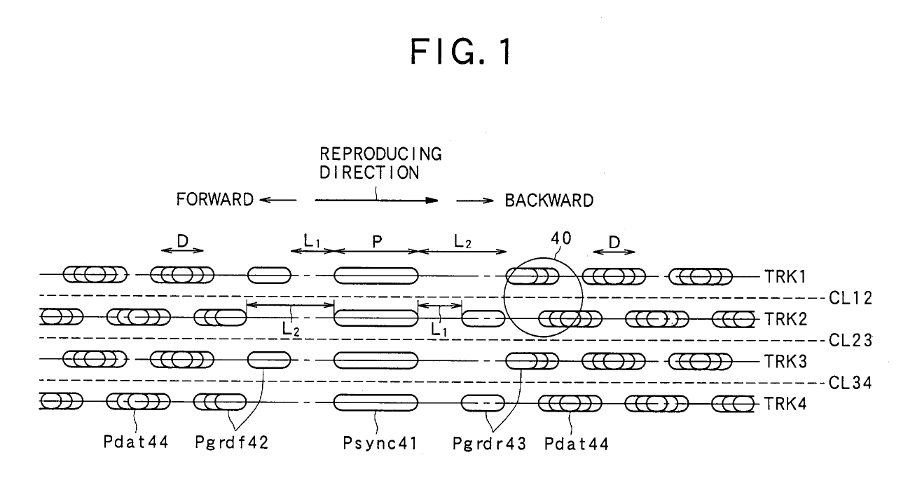

Referring to FIGS. 1 to 6, a first embodiment of an optical disk according to the present invention will be described below. FIG. 1 shows a pit configuration of the optical disk for reproduction using a sampled servo method. A pit means a concavity formed along a track direction of the optical disk, and consists of a synchronous pit as a synchronization reference for recording and reproduction of the optical disk, a guard pit, and a data pit corresponding to information to be recorded. In FIG. 1, the digital data is recorded as the information corresponding to the position of a pit edge in accordance with a multi-valued recording method.

The optical disk of this embodiment has a servo area composed of a synchronous pit (Psync) 41, a guard pit (Pgrdf) 42 and a guard pit (Pgrdr) 43 provided on each track (TRK) 1, 2, 3, 4, . . . and a data area composed of data pits (Pdat) 44, as indicated by a solid line in FIG. 1. A region between two adjacent tracks is referred to as centerlines (CL) 12, 23, 34, . . .

In reproducing the digital data of the optical disk according to the present invention, a beam spot 40 of the laser beam is traced on the centerlines CL12, CL23, CL34, . . . , from left to right in FIG. 1. In reproducing the digital data, a laser beam is applied on the centerline between two adjacent tracks to cover them to detect the quantity of light that is varied in accordance with a pattern of the data pits 44.

The data pits 44 are recorded in accordance with a pit edge multi-valued recording method. In the pit edge multi-valued recording, three valued data of 0, 1 and 2 are recorded corresponding to each pit edge of the data pit 44. Namely, a pit sequence at a fixed period is formed on the track, in which the position of the pit edge is varied at three steps in accordance with the digital data. Specifically, if the recording data is “0”, the position of the pit edge is shifted a certain distance in a direction where the pit length is shorter, if the recording data is “1”, the position of the pit edge is unchanged, or if the recording data is “2”, the position of the pit edge is shifted a certain distance in a direction where the pit length is longer. In this manner, the three valued digital data are recorded as the positional information of the pit edge. In FIG. 1, three positions of the pit edge are illustrated, but the actual pit edge takes one position.

The synchronous pit 41 serves as the synchronization reference at the time of reproduction. The synchronous pit 41 on each track is longer than other pits (e.g., P=2×D) to allow the reproducing apparatus to easily detect it, and aligned at the same position in a radial direction of the disk. Also, the synchronous pit 41 is a clock phase reference at the time of reproduction.

The guard pits 42 and 43 have the pit position changed in a tangential direction of the disk for every track. For example, in the odd tracks 1, 3, . . . , a land having a length L1 is provided between a leading part of the synchronous pit 41 and a trailing part of the guard pit 42, and a land having a length L2 is provided between a trailing part of the synchronous pit 41 and a leading part of the guard pit 43 (L1≠L2). A trailing part of the guard pit 43 is dealt with as the data, and modulated with the multi-value recording.

On the other hand, in the even tracks 2, 4, . . . , a land having the length L2 is provided between the leading part of the synchronous pit 41 and the trailing part of the guard pit 42, and a land having the length L1 is provided between the trailing part of the synchronous pit 41 and the leading part of the guard pit 43. The leading part of the guard pit 42 is dealt with as the data, and modulated with the multi-value recording.

The reproducing apparatus detects a tracking error from a signal on the basis of a reflected light from a land portion between the guard pits 42, 43 and the synchronous pit 41, and a land portion between two adjacent tracks, and performs a tracking servo so that the tracking error may be zero. Consequently, a beam spot 40 is traced on the centerlines CL12, CL23, CL34, . . . between two adjacent tracks, as shown in FIG. 1.

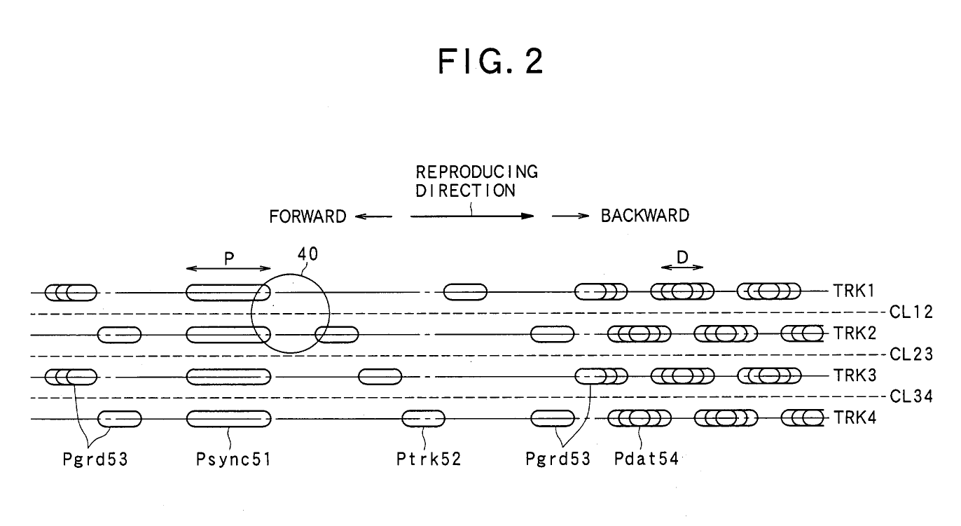

Referring to FIG. 2 to clarify features of the optical disk of the present invention, the pit configuration of the conventional optical disk using the same sampled servo method will be described below. A servo area consists of a synchronous pit (Psync) 51, a tracking pit (Ptrk) 52, and guard pits (Pgrd) 53 on the tracks (TRK) 1, 2, 3, . . . and a data area consists of data pits (Pdat) 54.

Herein, a tracking pit 52 for detecting the tracking error is provided, unlike this invention. The tracking pit 52 is disposed backward of the synchronous pit 51, in which the pit position in a tangential direction of the disk is varied at a period of four tracks. The reproducing apparatus detects a tracking error from an amplitude difference of reproduced signal between two tracking pits 52 located on two adjacent tracks, and performs a tracking servo so that the tracking error may be zero.

This tracking pit 52 is required for the tracking servo, whereby a space for providing the tracking pit 52 is required. Also, the space is larger due to the periodicity, whereby an area for recording the digital data is reduced. In the optical disk of the present invention, the tracking pit 52 can be omitted to increase the data recording capacity.

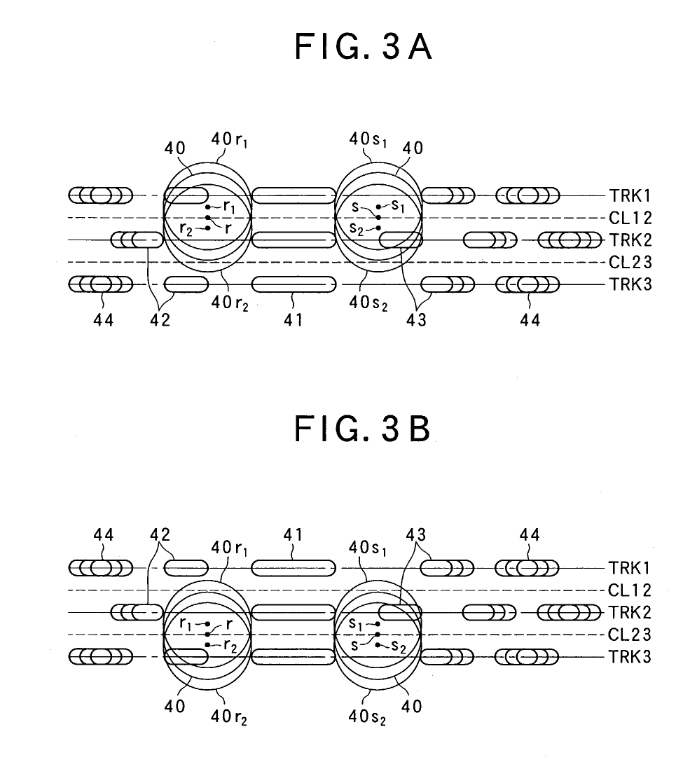

Referring to FIGS. 3 to 5, the pit arrangement of the optical disk of the present invention described above and a method of detecting the tracking error will be described below.

FIG. 3 is a view showing an array of the synchronous pit 41 and the guard pits 42 and 43, the beam spot 40, and sample extracting points r and s for the tracking servo. In FIG. 3A, the beam spot 40 lies on the odd centerline CL12, and in FIG. 3B, the beam spot 40 lies on the even centerline CL23.

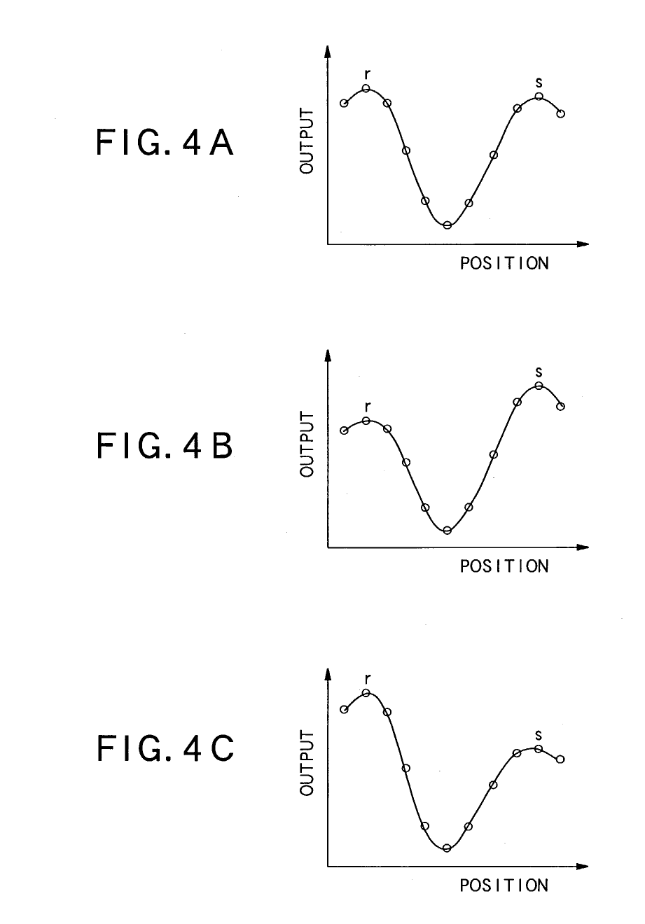

FIG. 4 is a view showing an output signal at the sample extracting points r and s for the tracking servo corresponding to the odd centerline of FIG. 3A. In FIG. 4A, the beam spot 40 lies on the centerline CL12, in FIG. 4B, the beam spot 40 is deviated upward from the centerline CL12, and in FIG. 4C, the beam spot 40 is deviated downward from the centerline CL12.

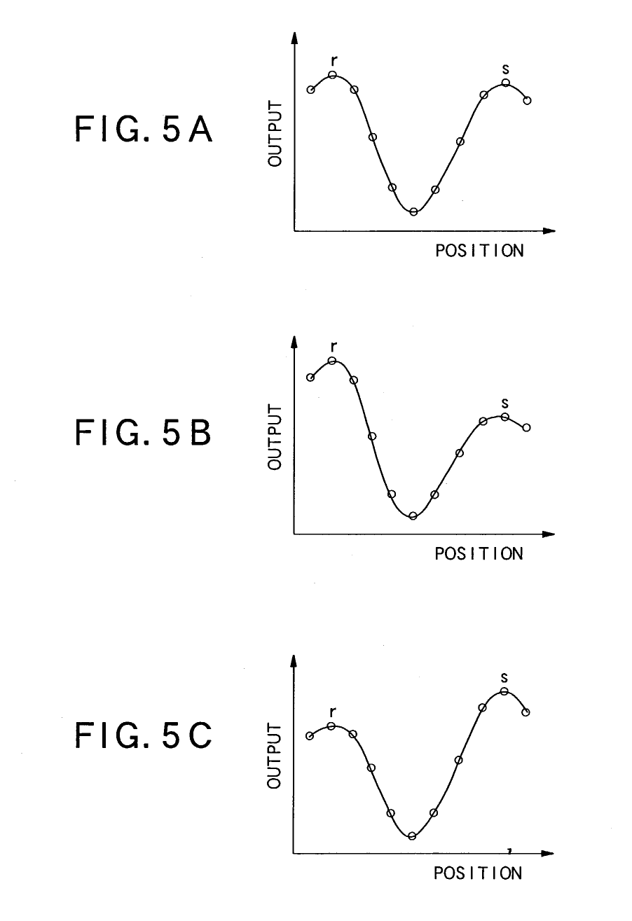

FIG. 5 is a view showing an output signal at the sample extracting points r and s for the tracking servo corresponding to the even centerline of FIG. 3B. In FIG. 5A, the beam spot 40 lies on the centerline CL23, in FIG. 5B, the beam spot 40 is deviated upward from the centerline CL23, and in FIG. 4C, the beam spot 40 is deviated downward from the centerline CL23. A sample extracting point r is provided at an intermediate position between the leading part of the synchronous pit 41 and the trailing part of the guard pit 42 in the track 2, and a sample extracting point s is provided at an intermediate position between the trailing part of the synchronous pit 41 and the leading part of the guard pit 43 in the track 1. The points r and s are points at which the reproduced output with the reflected lights from respective lands is at peak, in which a tracking error is detected by sampling and holding the peak of this output. Also, it is desirable to control a diameter of the beam spot 40 to be almost equal to a distance between the leading part of the synchronous pit 41 and the trailing part of the guard pit 42 in the track 2.

Firstly, in the case where the beam spot 40 is traced on the centerline CL12, the beam spot 40 lies at the points r and s, as shown in FIG. 3A, whereby the sample is extracted at the points r and s. At this time, the beam spot 40 is applied evenly on two adjacent tracks 1 and 2.

Also, in the case where the beam spot 40 is moved upward from the centerline CL12 for tracing, or a tracking error occurs above, the beam spot 40 lies at points r₁ and s₁, whereby more radiation is made on the track 1 than the track 2, as indicated by the beam spot 40r₁ and the beam spot 40s₁.

On the other hand, in the case where the beam spot 40 is moved downward from the centerline CL12 for tracing, or a tracking error occurs below, the beam spot 40 lies at points r₂ and s₂, whereby more radiation is made on the track 2 than the track 1, as indicated by the beam spot 40r₂ and the beam spot 40s₂.

Next, in the case where the beam spot 40 is traced on the centerline CL23, the beam spot 40 lies at the points r and s, as shown in FIG. 3B, whereby the sample is extracted at the points r and s. At this time, the beam spot 40 is radiated evenly on two adjacent tracks 2 and 3.

Also, in the case where the beam spot 40 is moved upward from the centerline CL23 for tracing, or a tracking error occurs above, the beam spot 40 lies at points r₁ and s₁, whereby more radiation is made on the track 2 than the track 3, as indicated by the beam spot 40r₁ and the beam spot 40s₁.

On the other hand, in the case where the beam spot 40 is moved downward from the centerline CL23 for tracing, or a tracking error occurs below, the beam spot 40 lies at points r₂ and s₂, whereby more radiation is made on the track 3 than the track 2, as indicated by the beam spot 40r₂ and the beam spot 40s₂.

As described above, with the position of the beam spot 40, there occurs a change in the amount of reflected light from the land with the arrangement of the synchronous pit 41 and the guard pits 42 and 43 and the land between two tracks, whereby a tracking error can be detected.

Referring to FIG. 4, the detection of tracking error in the state of FIG. 3A will be described below. FIG. 4A shows an output signal when the beam spot 40 is traced on the centerline CL12, as shown in FIG. 3A, in which an output at point r and an output at point s take the almost same level. No tracking error occurs in this case.

FIG. 4B shows an output signal when the beam spot 40 is traced above the centerline CL12, in which the output at point s is larger than the output at point r. This is because the point s is less affected by the guard pit 43, and has a greater amount of reflected light, while the point r is greatly affected by the guard pit 42, and has a smaller amount of reflected light. Accordingly, a comparison between the output at point r and the output at point s reveals that the tracking is deviated upward, whereby a tracking error is detected.

FIG. 4C shows an output signal when the beam spot 40 is traced below the centerline CL12, in which the output at point r is larger than the output at point s. This is because the point r is less affected by the guard pit 42, and has a greater amount of reflected light, while the point s is greatly affected by the guard pit 43, and has a smaller amount of reflected light. Accordingly, a comparison between the output at point r and the output at point s reveals that the tracking is deviated downward, whereby a tracking error is detected.

Referring to FIG. 5, the detection of tracking error in the state of FIG. 3B will be described below. FIG. 5A shows an output signal when the beam spot 40 is traced on the centerline CL23, as shown in FIG. 3B, in which the output at point r and the output at point s take the almost same level. No tracking error occurs in this case.

FIG. 5B shows an output signal when the beam spot 40 is traced above the centerline CL23, in which the output at point r is larger than the output at point s. This is because the point r is less affected by the guard pit 42, and has a greater amount of reflected light, while the point s is greatly affected by the guard pit 43, and has a smaller amount of reflected light. Accordingly, a comparison between the output at point r and the output at point s reveals that the tracking is deviated upward, whereby a tracking error is detected.

FIG. 5C shows an output signal when the beam spot 40 is traced below the centerline CL23, in which the output at point s is larger than the output at point r. This is because the point s is less affected by the guard pit 43, and has a greater amount of reflected light, while the point r is greatly affected by the guard pit 42, and has a smaller amount of reflected light. Accordingly, a comparison between the output at point r and the output at point s reveals that the tracking is deviated downward, whereby a tracking error is detected.

As will be apparent from FIGS. 4 and 5, the polarity of the tracking error in the same direction is changed for every centerline to be traced. Accordingly, when the tracking servo is practically performed, it is required that the polarity of the tracking error signal is reversed for every centerline, namely, for every track. In the case where the recording is made in a format where the polarity is changed for every frame, it is naturally required that the polarity is reversed for every frame.

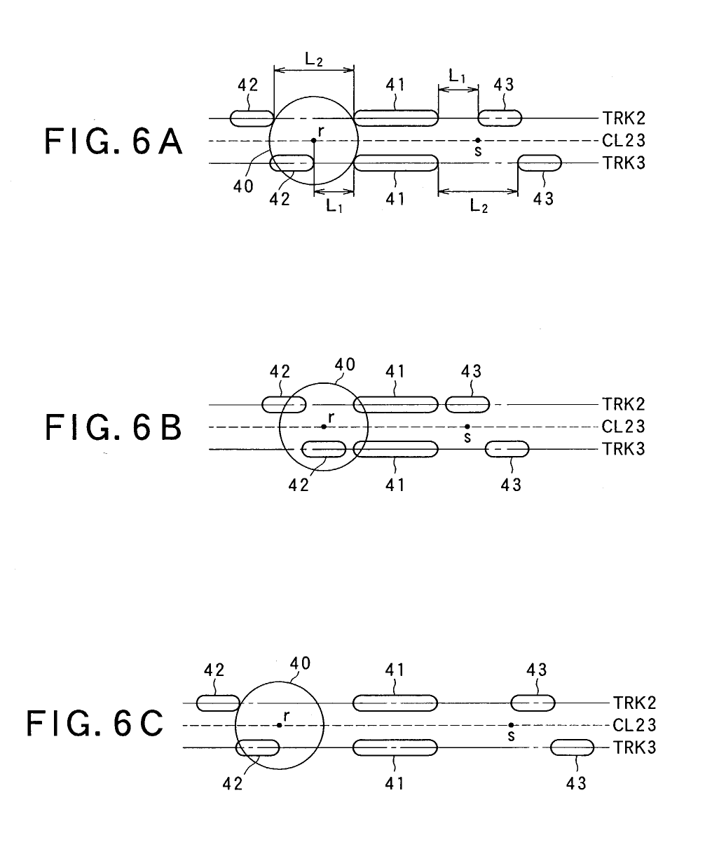

Referring to FIG. 6, a relation between the arrangement of the synchronous pit 41 and the guard pits 42 and 43 for detecting the tracking error efficiently and at high quality and the beam spot 40 will be described below.

FIG. 6A shows an optimal relation. Assuming that a distance between the synchronous pit 41 and the guard pit 42 is L2 and a distance between the synchronous pit 41 and the guard pit 43 is L1 in the even track (e.g., TRK2), and the distance between the synchronous pit 41 and the guard pit 42 is L1 and the distance between the synchronous pit 41 and the guard pit 43 is L2 in the odd track (e.g., TRK3), L2=2×L1. Also, the point r for sample extraction is set at an intermediate position of L2, and the diameter of the beam spot 40 is configured almost equal to L2. Thereby, the reflected light of the beam spot 40 is affected only by the guard pit 42 on the odd track, but not affected by other pits, whereby the tracking error signal with high S/N ratio is detected. At point s, the reflected light is affected only by the guard pit 43 on the even track, whereby the tracking error signal with high S/N ratio is detected, like point r. The even track and the odd track are called simply to distinguish the tracks for convenience, and characterized by the arrangement of the synchronous pit 41 and the guard pits 42 and 43.

In FIG. 6B, the distance between the synchronous pit 41 and the guard pits 42 and 43 is shorter, and the tracking error signal is affected by other pits to cause the S/N ratio to be degraded, although the recording density is increased.

Further, in FIG. 6C, the distance between the synchronous pit 41 and the guard pits 42 and 43 is longer, and the S/N ratio of the tracking error signal remains the same, but the recording density is decreased.

As above described, if the beam spot is traced off the centerline between two adjacent tracks, a tracking error is obtained corresponding to a deviation of the beam spot. By feeding this deviation back to the pick-up, the deviation of the beam spot is corrected, so that the correct tracking servo is made. That is, the beam spot is accurately traced on the centerline between two adjacent tracks. Since this detection method for the tracking error signal has a high detection sensitivity, it is possible to make a stable and accurate tracking servo, when the track pitch is narrow, or the pit period is short.

Second Embodiment of Optical Disk

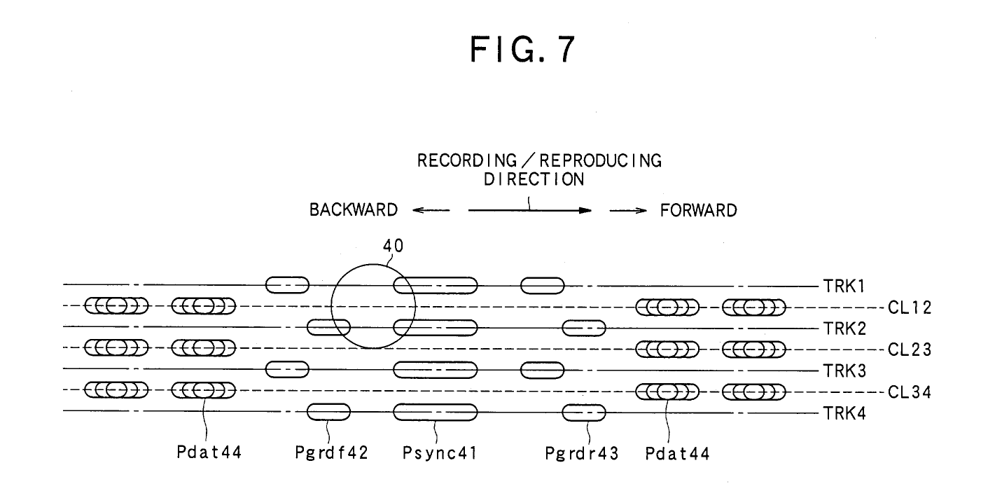

Referring to FIG. 7, a second embodiment of the optical disk will be described below. This second embodiment involves a write-once disk having a pigment film, and a rewritable disk having a phase change film or MO film.

The pit configuration has a servo area composed of a synchronous pit (Psync) 41, a guard pit (Pgrdf) 42 and a guard pit (Pgrdr) 43 provided on each track (TRK) 1, 2, 3, 4, . . . and a recording area for recording data pits (Pdat) 44 corresponding to the digital data in a region between two adjacent tracks, as shown in FIG. 7. This recording area corresponds to a region of the centerlines (CL) 12, 23, 34, . . . .

The arrangement and size of the synchronous pit 41 and the guard pits 42 and 43, the detection of tracking error, and the formation of error signal for tracking servo are the same as in the first embodiment, and are not described here.

The beam spot 40 is traced on the centerlines 12, 23, 34, . . . on the basis of the tracking error signal obtained by the arrangement of pits on two adjacent tracks to record the data pits 44 corresponding to the digital data in the recording area.

The data pits 44 recorded on the centerlines 12, 23, 34, . . . are recorded by the pit edge multi-valued recording method. In the pit edge multi-valued recording, three valued data of 0, 1 and 2 is recorded corresponding to each pit edge of the data pit 44. In FIG. 7, the positions of three pit edges are illustrated, but the pit edge of the data pit 44 actually recorded takes any one position.

Thus, the first and second embodiments of the optical disk according to the present invention have been described in detail. However, by exchanging the pit and the land, the tracking servo may be made on the basis of the reproduced signal of pits located between the synchronous land and the guard lands.

Embodiment of Optical Disk Recording/Reproducing Apparatus

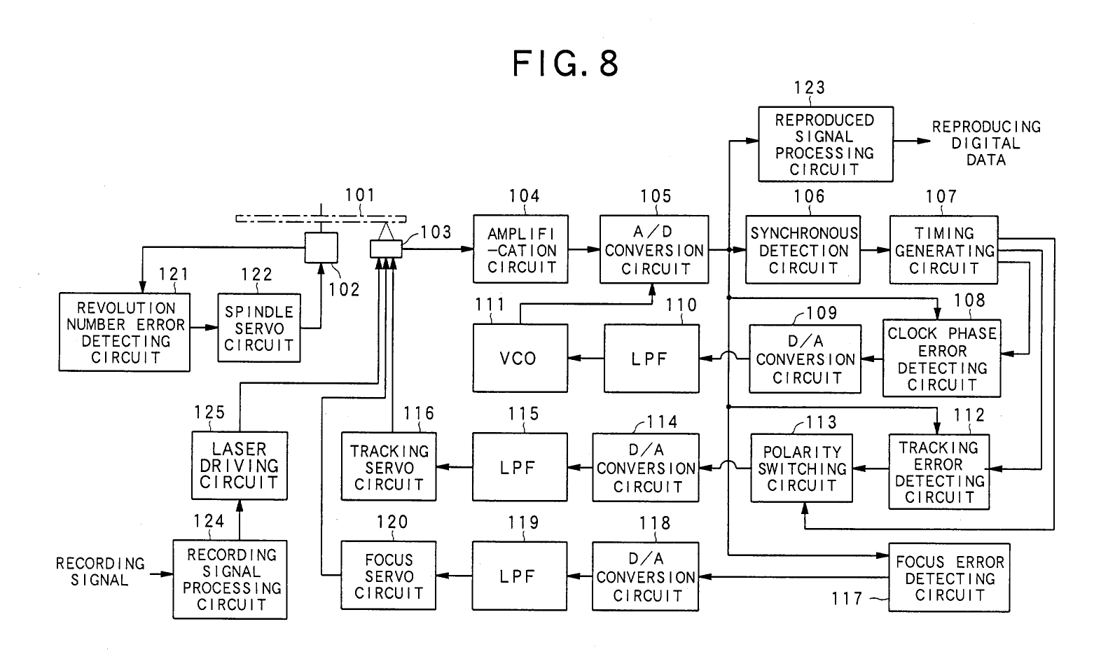

Referring to FIG. 8, an optical disk recording/reproducing apparatus for recording and reproducing data on and from the optical disk of FIG. 7 using a sampled servo method will be described below.

First of all, a configuration and an operation of a reproducing system will be described. An optical pick-up 103 irradiates a laser beam of low power on a disk surface of an optical disk 101 in reproducing the digital data, and detects the amount of reflected light changing in accordance with the data pits 44 to output a reproduced signal.

An amplification circuit 104 amplifies a reproduced signal from the optical pick-up 103. An A/D conversion circuit 105 converts the reproduced signal from analog to digital form in synchronism with a reproduction clock to output a sample sequence. A reproduced signal processing circuit 123 makes the digital signal processing for the sample sequence output from the A/D conversion circuit 105 to restore the digital data recorded on the optical disk 101 as the reproduced digital data.

A synchronous detection circuit 106 detects a sample corresponding to the synchronous pit from the sample sequence output from the A/D conversion circuit 105 to output a synchronous detection signal. A timing generating circuit 107 generates various kinds of timing signals in reference to the synchronous detection signal output from the synchronous detection circuit 106 and supplies them to a clock phase error detecting circuit 108, a tracking error detecting circuit 112 and a polarity switching circuit 113.

The clock phase error detecting circuit 108 extracts the samples for the pit edges on both sides of the synchronous pit from the sample sequence in accordance with a timing signal output from the timing generating circuit 107, and calculates a level difference between both samples to output the phase error data.

A D/A conversion circuit 109 converts the phase error data output from the clock phase error detecting circuit 108 from digital to analog form to output a phase error signal. An LPF (Low Pass Filter) 110 removes the high frequency components contained in the phase error signal output from the D/A conversion circuit 109 to smooth the waveform. A VCO (Voltage Controlled Oscillation) 111 changes the oscillation frequency of clock in accordance with a voltage passed through the LPF 110 to generate a reproduction clock phased with the reproduced signal.

The A/D conversion circuit 105, the clock phase error detecting circuit 108, the D/A conversion circuit 109, the LPF 110, and the VCO 111 make up a PLL (Phase Locked Loop). The PLL is a servo loop for phasing the reproduction clock to the reproduced signal.

A tracking error detecting circuit 112 extracts the samples corresponding to points r and s of FIG. 3 from the sample series according to the timing signal, and calculates a level difference between both samples to output the tracking error data. A tracking error has the polarity changed for every frame or every track in accordance with a recording format. A polarity switching circuit 113 reverses the polarity of the tracking error for every frame or every track, depending on the timing signal to output a tracking error.

A D/A conversion circuit 114 converts the tracking error data from digital to analog form to output a tracking error signal. An LPF 115 removes the high frequency components contained in the tracking error signal output from the D/A conversion circuit 114 to smooth the waveform. A tracking servo circuit 116 controls the position of the optical pick-up 103 in the radial direction of the disk to trace the beam spot of the optical pick-up 103 along the predetermined line in accordance with the tracking error signal passed through the LPF 115.

The amplification circuit 104, the A/D conversion circuit 105, the tracking error detecting circuit 112, the D/A conversion circuit 114, the LPF 115, the tracking servo circuit 116, and the optical pick-up 103 make up a tracking servo loop. The tracking servo loop is a servo loop for causing the beam spot of laser beam to trace on the centerline between two adjacent tracks.

To constitute a focus servo loop, a focus error detecting circuit 117 detects a focus error on the basis of an output of the A/D conversion circuit 105. A D/A conversion circuit 118 converts the focus error from digital to analog form to output a focus error signal. An LPF 119 removes the high frequency components contained in the focus error signal to smooth the waveform. A focus servo circuit 120 controls the beam spot of the optical pick-up 103 to be focused on the disk surface in accordance with a focus error signal passed through the LPF 119.

Moreover, to control the number of revolutions of the spindle motor 102 for revolving the optical disk 101, a spindle servo circuit is provided to control the number of revolutions of the spindle motor 102 on the basis of an error signal from a revolution number error detecting circuit 121. The information regarding the number of revolutions from a signal reproduced by the optical pick-up 103 may be detected in the revolution number error detecting circuit 121 and applied to the spindle servo circuit 122. Particularly, this is required for the revolution control at a constant linear velocity.

A recording system comprises a recording signal processing circuit 124 for producing a recording signal by digitizing the signal to be recorded, converting it into a predetermined format, and adding the necessary information for error correction or the like, and a laser driving circuit 125 for driving a laser of high power for recording on the basis of an output signal from the recording signal processing circuit 124. The recording system can employ the tracking servo, the focus servo and the spindle servo of the reproducing system.

The optical disk recording/reproducing apparatus has been described above. However, a reproduction dedicated apparatus and a recording dedicated apparatus may be constituted by extracting the respectively corresponding functions of the optical disk recording/reproducing apparatus.

This invention is not limited to the above embodiments, but may be modified or varied appropriately without departing from the scope and spirit of the invention as defined by the appended claims and described in the entire specification. It is intended that the modified optical disk and the modified optical disk recording/reproducing apparatus may also fall within the technical scope of the invention.

As described above, since the tracking servo is made by detecting a tracking error from a reflected light from the land portion between the synchronous pit and the guard pits and the land portion between two adjacent tracks, the conventional tracking pit is unnecessary, whereby the area for recording the data can be widely kept.

If the interval between the synchronous pit and the guard pits disposed before and after the synchronous pit, namely, the distance between the synchronous pit and the guard pit, is set with a certain relation in view of the odd track and the even track, the amplitude of the signal due to the reflected light from the land portion can be fully increased. Accordingly, even when the pit period is short, a correct tracking error can be detected, whereby the optical disk recording/reproducing apparatus has the enhanced performance.

The entire disclosure of Japanese Patent Application No. 2002-130072 filed on May 1, 2002 including the specification, claims, drawings and summary is incorporated herein by reference in its entirety.

What is claimed is:

1. An optical disk having a synchronous pit serving as a synchronizing reference for recording/reproducing, guard pits and data pits on each track, comprising:
on an odd track,
a first land having a first length between the synchronous pit and the guard pit provided forward of the synchronous pit; and
a second land having a second length between the synchronous pit and the guard pit provided backward of the synchronous pit;
on an even track,
a third land having a third length between the synchronous pit and the guard pit provided forward of the synchronous pit; and
a fourth land having a fourth length between the synchronous pit and the guard pit provided backward of the synchronous pit,
wherein a tracking error signal is detected on the basis of a reflected light from the first land, the third land, and a land between the odd track and the even track adjacently provided, and a reflected light from the second land, the fourth land, and a land between the odd track and the even track adjacently provided.

2. The optical disk according to claim 1, wherein the first length of the first land is equal to the fourth length of the fourth land, and the second length of the second land is equal to the third length of the third land.

3. The optical disk according to claim 1, wherein the first length of the first land is not equal to the second length of the second land.

4. The optical disk according to claim 1, wherein the second length of the second land is two times longer than the first length of the first land, and the second length of the second land is two times longer than an average length of the data pits.

5. The optical disk according to claim 1, wherein the synchronous pit on said each track is arranged at the same position in a radial direction of the optical disk.

6. The optical disk according to claim 1, wherein the synchronous pit has a longer shape than the guard pits and the data pits.

7. The optical disk according to claim 1, wherein a trailing part of the guard pit arranged backward of the synchronous pit on the odd track is modulated in accordance with the recorded data.

8. The optical disk according to claim 1, wherein a leading part of the guard pit arranged forward of the synchronous pit on the even track is modulated in accordance with the recorded data.

9. The optical disk according to claim 1, wherein the data pits record multi-level digital data as the positional information of their pit edges.

10. The optical disk according to claim 1, wherein a material capable of optically forming the data pit is provided at least between the adjacent two tracks of the optical disk.

11. An optical disk recording/reproducing apparatus for performing at least one of recording and reproducing data on and from an optical disk having a synchronous pit as a synchronization reference for recording/reproducing, guard pits and data pits on each track, comprising:
an optical device which performs at least one of recording and reproducing data by radiating a beam spot of laser beam over two adjacent tracks of the optical disk;
a tracking error detecting device which detects a tracking error signal on the basis of a reflected light from a land between the synchronous pit and the guard pits and a land provided between the adjacent two tracks; and
a tracking servo device which enables the beam spot of laser beam to trace the center between the adjacent two tracks on the basis of the tracking error signal by the tracking error detecting device.

12. The optical disk recording/reproducing apparatus according to claim 11, wherein the tracking error detecting device samples, at a predetermined position, a reproduced signal level on the basis of a reflected light from the land between the synchronous pit and the guard pit arranged forward of the synchronous pit and the land provided between the adjacent two tracks, and a reproduced signal level on the basis of a reflected light from the land between the synchronous pit and the guard pit arranged backward of the synchronous pit and the land provided between the adjacent two tracks, and detects a tracking error by comparing the sampled values.

13. The optical disk recording/reproducing apparatus according to claim 12, wherein a comparison result of the sampled values by the tracking error detecting device is supplied to the tracking servo device, with the polarity reversed for each track.

14. The optical disk recording/reproducing apparatus according to claim 12, wherein a comparison result of the sampled values by the tracking error detecting device is supplied to the tracking servo device, with the polarity reversed for each frame.
